(19) United States
(12) Patent Application Publication
(10) Pub. No.: US 2009/0089845 A1
(43) Pub. Date: Apr. 2, 2009

(54) VIDEO STORAGE AND RETRIEVAL SYSTEM

(76) Inventors: William Rex Akers, Colleyville, TX (US); Brian Marcus Hudson, Irving, TX (US); Larry James Stephenson, JR., Fort Worth, TX (US); Phillip Scott Taylor, Bedford, TX (US); Christopher Lynn Jobe, Arlington, TX (US); William Michael McManus, Colleyville, TX (US)

Correspondence Address: CARR LLP, 670 FOUNDERS SQUARE, 900 JACKSON STREET, DALLAS, TX, 75202, US

(21) Appl. No.: 12/239,486

(22) Filed: Sep. 26, 2008

Related U.S. Application Data
(60) Provisional application No. 60/975,904, filed on Sep. 28, 2007.

(51) Int. Cl. H04N 7/173; H04N 7/18

(52) U.S. Cl. 725/88; 348/143; 725/92; 348/E07.085

(57) ABSTRACT

A method for video data retrieval is provided. The method comprises receiving a search criteria, the search criteria comprising an identification of an event recording system and an identification of a type of timestamp of an event record of the event recording system, retrieving from the event recording system identified by the search criteria an at least one event record, each event record comprising a timestamp identified by the search criteria, and retrieving from a digital video recorder server an at least one video record with a timing data encompassing the timestamp of the at least one event record, the timestamp of the type identified by the search criteria.

### CROSS-REFERENCE TO RELATED APPLICATIONS

This application relates to, and claims the benefit of the filing date of, co-pending U.S. provisional patent application Ser. No. 60/975,904 entitled VIDEO STORAGE AND RETRIEVAL SYSTEM, filed Sep. 28, 2007, the entire contents of which are incorporated herein by reference for all purposes.

### TECHNICAL FIELD

The present invention relates to video storage and retrieval systems and, more particularly, to video retrieval from a collection of videos based on events occurring during the time the video was recorded.

### BACKGROUND

Pharmacies typically contain video cameras to monitor activity within the pharmacy. Recordings from these video cameras can be used to identify perpetrators of crime, to monitor pharmacy personnel, to verify correct procedures are being followed, and so on. However, video camera systems do not typically attach any meaning to the videos they record. Thus, a person wanting to view a camera's video of a specific event must watch through the camera's video recordings of all possible times the event occurred until the person finds the video of the event. This process can often be time-consuming, especially if there are many possible times the event could have occurred.

Thus, a need exists for a way to search through video for a specific event or set of events. These events should be identifiable by meaningful attributes, such as the customer associated with the filling of a specific prescription. A user could then search through video for events with attributes meeting desired criteria.

### SUMMARY OF INVENTION

Accordingly, a method for video data retrieval is provided in one exemplary embodiment of the present invention. The method comprises receiving a search criteria, the search criteria comprising an identification of an event recording system and an identification of a type of timestamp of an event record of the event recording system, retrieving from the event recording system identified by the search criteria an at least one event record, each event record comprising a timestamp identified by the search criteria, and retrieving from a digital video recorder server an at least one video record with a timing data encompassing the timestamp of the at least one event record, the timestamp of the type identified by the search criteria.

### BRIEF DESCRIPTION OF THE DRAWINGS

For a more complete understanding of the present invention and the advantages thereof, reference is now made to the following Detailed Description taken in conjunction with the accompanying drawings, in which:

FIG. 1 is a diagram of an exemplary embodiment the present invention;

FIG. 2 is a diagram of the event recording systems of FIG. 1;

FIG. 3 is a diagram of the DVR server of FIG. 1;

FIG. 4 is a diagram of the data warehouse application search processor of FIG. 1;

FIG. 5 is a flowchart of a process for storing event information to be retrieved by the present invention;

FIG. 6 is a flowchart of a process for storing video data to be retrieved by the present invention;

FIG. 7 is a flowchart of a process for retrieving video data in accordance with the present invention;

FIG. 8 is a flowchart of a process for retrieving video data across the Internet in accordance with the present invention; and

FIG. 9 is a flowchart of a process for periodically searching for video data using the present invention.

### DETAILED DESCRIPTION OF THE INVENTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, specific details, and the like have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or as software instructions for enabling a computer to perform predetermined operations, where the software instructions are embodied on a computer readable storage medium, such as RAM, a hard drive, flash memory or other type of computer readable storage medium known to a person of ordinary skill in the art. In certain embodiments, the predetermined operations of the computer are performed by a processor such as a computer or an electronic data processor in accordance with code such as computer program code, software, and, in some embodiments, integrated circuits that are coded to perform such functions.

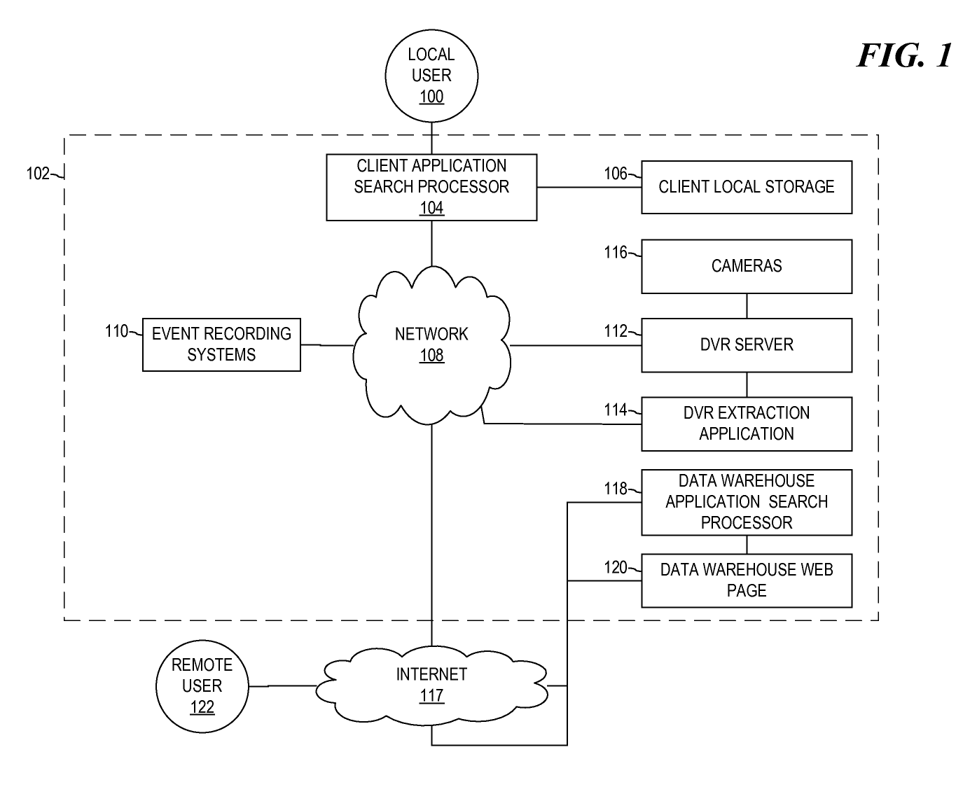

Referring to FIG. 1, a local user 100 interacts with an apparatus 102 through a client application search processor 104. The client application search processor 104 may be hardware, such as one or more processors or computers which store and execute computer program code embodied on a computer readable storage medium. The client application search processor 104 may have client local storage 106.

The client application search processor 104 may be connected to a network 108. Also connected to the network 108 may be an event recording systems 110, a Digital Video Recorder (DVR) server 112, and a DVR extraction application 114. The DVR server 112 may receive video data from a cameras 116 and may be connected to the DVR extraction application 114.

The network 108 may be connected to an Internet 117. In other embodiments, the Internet 117 may be replaced with another telecommunications network. A data warehouse application search processor 118 and a data warehouse web page 120 may also be connected to the Internet 117. The data warehouse application search processor 118 and the data warehouse web page 120 may also be connected to each other. The data warehouse application search processor 118 and the data warehouse web page 120 may be hardware, such as one or more processors or computers which store and execute computer program code embodied on a computer readable storage medium. A remote user 122 may interact with the apparatus 102 through the data warehouse web page 120 via the Internet 117.

The client application search processor 104 and the data warehouse application search processor 118 are search processors. Search processors may be configured to perform searches of the apparatus 102 for video recordings, as explained below. Data warehouse application search processor 118 may serve as a second storage location for data stored in event recording systems 110 and DVR server 112, as explained below.

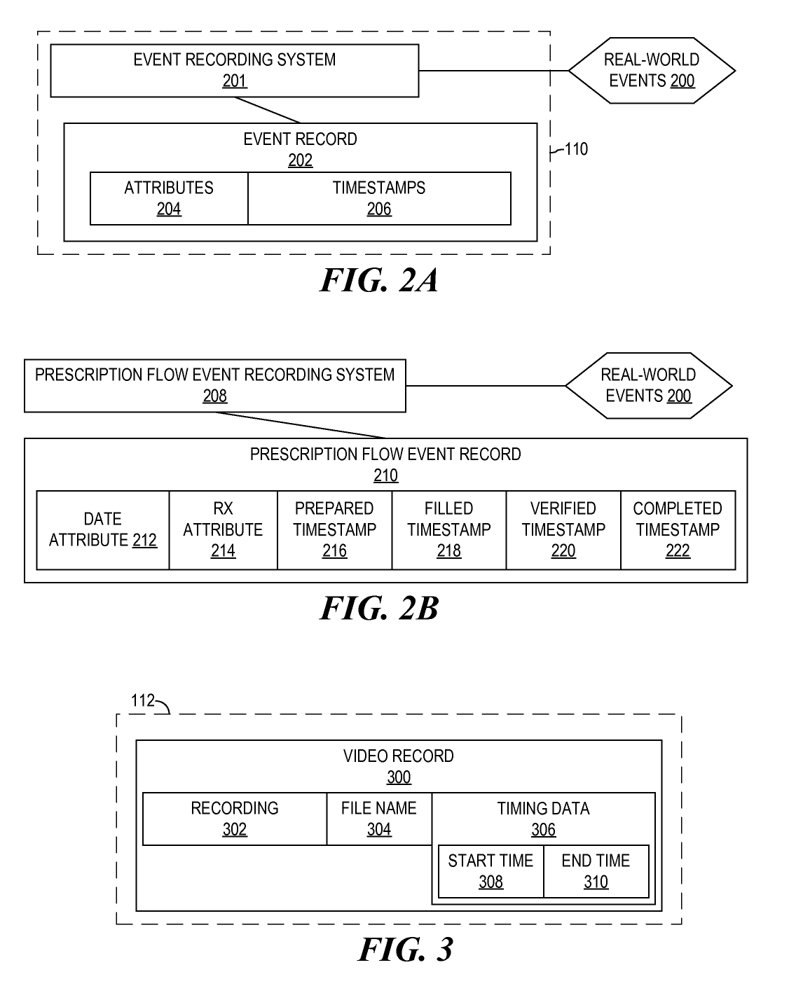

Referring to FIG. 2A, the event recording systems 110 may comprise an at least one event recording system 201. Each event recording system 201 may record occurrences of a category of a real-world events 200. An event recording system 201 may record, for example, the clocking in and out of workers in a time clock. An event recording system 201 may store information about a category of the real-world events 200 in an at least one event record 202. What types of the real-world events 200 are recorded may depend on the particular event recording system 201.

An event record 202 may comprise two types of information about a corresponding real-world event or events 200, attributes 204 and timestamps 206. An attributes 204 may categorize real-world events 200 and may not correspond to a specific time and date. A timestamps 206 comprises specific times and dates that relevant real-world events 200 occurred. What information about the real-world events 200 may be stored in the attributes 204 and the timestamps 206 may depend on the particular event recording system 201.

Referring to FIGS. 2A and 2B, a prescription flow event recording system 208 is a specific example of an event recording system 201. The prescription flow event recording system 208 records information about occurrences of a prescription flow real-world events 207. The prescription flow real-world events 207 are a category of the real-world events 200 that involve the flow of a prescription through a pharmacy. Information about the occurrences is recorded in a prescription flow event record 210. A prescription flow event record 210 is a class of event record 202. Each prescription flow event record 210 corresponds to the processing of a specific prescription by the pharmacy.

An attributes 204 of a prescription flow event record 210 comprises a date attribute 212 and a Rx attribute 214. The date attribute 212 is the date of the prescription that corresponds to the prescription flow event record 210. The Rx attribute 214 is an identifier for the prescription that corresponds to the prescription flow event record 210. A timestamps 206 of a prescription flow event record 210 comprises a prepared timestamp 216, a filled timestamp 218, a verified timestamp 220, and a completed timestamp 222. These timestamps respectively contain the times and dates that the prescription identified by Rx attribute 214 was prepared, filled, verified, and completed.

Referring to FIG. 3, DVR Server 112 may contain an at least one video record 300. A video record 300 may comprise a recording 302, a file name 304, and a timing data 306. The recording 302 may be a video recording of activities in a location, such as a pharmacy, from a camera 116 (FIG. 1). As used herein, a video recording may be a visual recording, an audio recording, or a combination of audio and visual recordings. The file name 304 may be a unique identifier for each video record.

The timing data 306 may comprise a start time 308 and an end time 310. The start time 308 may be the time and date that the recording 302 began. The end time 310 may be the time and date that the recording 302 ended. The timing data 306 may be said to “encompass” a given time and date if the start time 308 is at least as early as the given time and date and the end time 310 is at least as late as the given time and date.

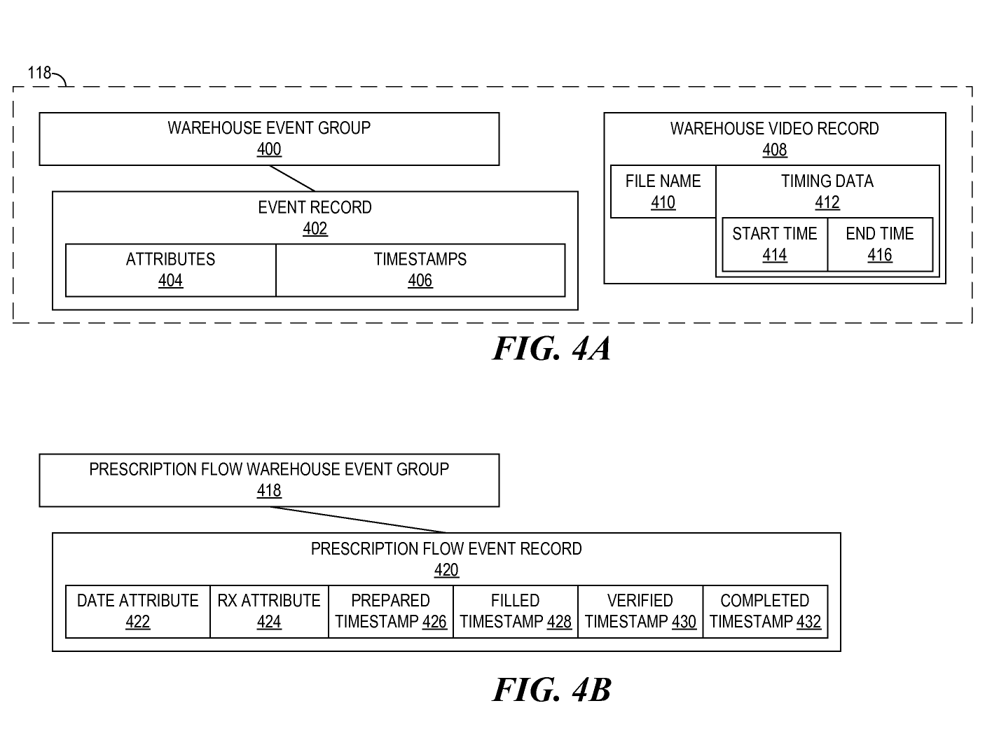

Referring to FIG. 2A and FIG. 4A, a data warehouse application search processor 118 may contain an at least one warehouse event group 400. Each warehouse event group 400 may correspond to an event recording system 201. A warehouse event group 400 may contain an at least one event record 402. The at least one event record 402 contained by the warehouse event group 400 may be identical to an at least one event record 202 contained by the event recording system 201 corresponding to the warehouse event group 400. The attributes 404 and timestamps 406 of the at least one event record 402 may be the same as the attributes 204 and timestamps 206 of the at least one event record 202.

The data warehouse application search processor 118 may also contain an at least one warehouse video record 408. The at least one warehouse video record 408 may be identical to an at least one corresponding video record 300 (FIG. 3) except for not comprising a recording. The at least one warehouse video record 404 may comprise a file name 410 and a timing data 412.

Referring now to FIG. 2B and FIG. 4B., a prescription flow warehouse event group 418 is a specific example of a warehouse event group 400. The prescription flow warehouse event group 418 corresponds to a prescription flow event recording system 204. Each prescription flow event record 210 stored in the prescription flow event recording system 208 has a corresponding prescription flow event record 420 stored in the prescription flow warehouse event group 418. A date attribute 422, Rx attribute 424, prepared timestamp 426, filled timestamp 428, verified timestamp 430, and completed timestamp 432 of the prescription flow event record 420 are respectively identical to a date attribute 212, Rx attribute 214, prepared timestamp 216, filled timestamp 218, verified timestamp 210, and completed timestamp 212 of the corresponding prescription flow event record 210.

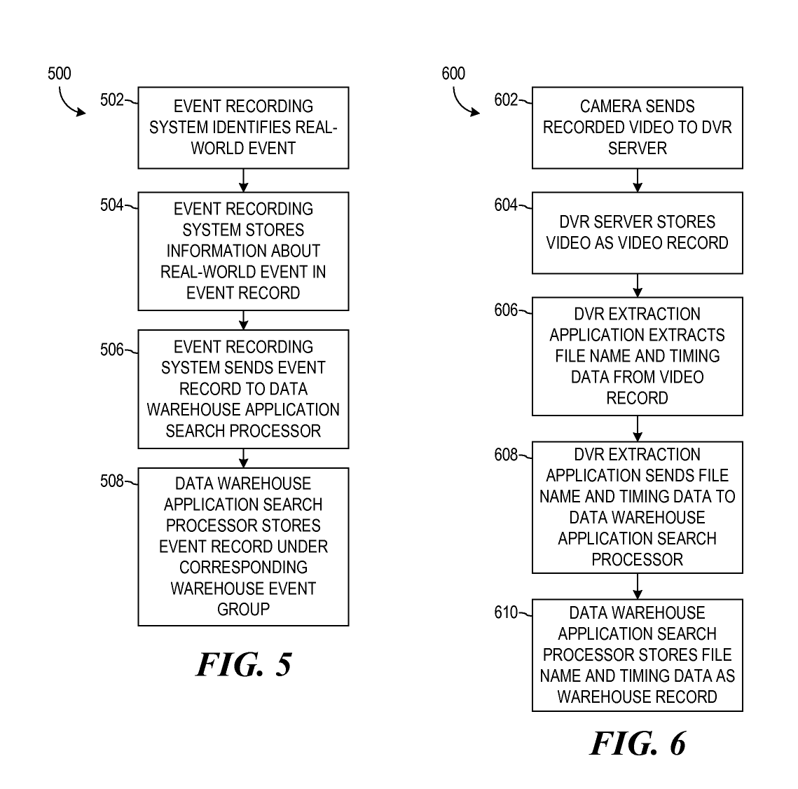

Referring now to FIG. 5, the process 500 describes how information about a real-world event 202 may be stored. In operation 502, an event recording system 110 may identify a real-world event 202. How the event recording system 110 identifies the real-world event 202 may depend on the specific event recording system 110. The real-world event 202 may be identified by the reading of a barcode, the manual entry of data, or some other means.

In operation 504, the event recording system 110 may store information about the real-world event 200 in an event record 204. Which information may be stored may be dependent on the event-recording system 110. In operation 506, the event recording system 110 may send the event record 204 to a data warehouse application search processor 118 via a network 108 and an Internet 117. In operation 508, the data warehouse application search processor 118 may store the event record 204 in the warehouse event group 400 corresponding to the event recording system 110 that created the event record 204.

Referring now to FIG. 6, the process 600 describes how video recorded by a camera 116 may be stored in the apparatus 102. In operation 602, the camera 116 may transmit a recorded video to a DVR server 112. In operation 604, the DVR server 112 may store the recorded video as a video record 300. In operation 606, a DVR extraction application 114 may extract a file name 304 and a timing data 306 from the video record 300 in the DVR server 112. In operation 608, the DVR extraction application 114 may send the file name 304 and the timing data 306 through the network 108 and the Internet 117 to a data warehouse application search processor 118. In operation 610, the data warehouse application search processor 118 may store the file name 304 and the timing data 306 in a warehouse video record 408.

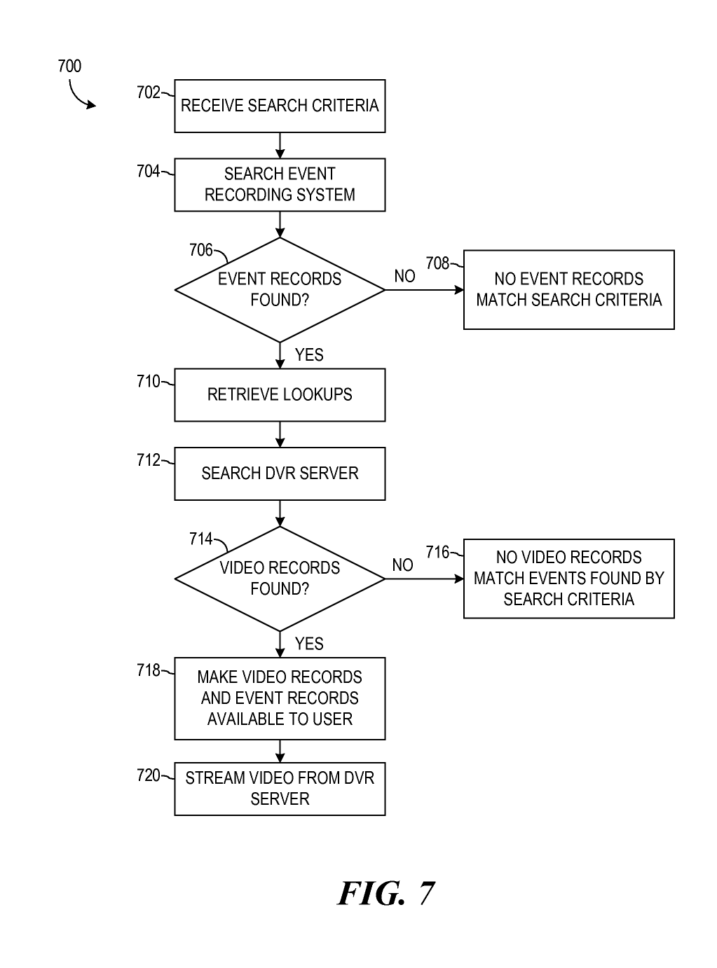

Referring now to FIG. 7, the process 700 describes operations a local user 100 may use in retrieving video data using the present invention. The local user 100 may seek to retrieve from an apparatus 102 an at least one recording 302 of an at least one real-world event 202 which meets certain criteria defined by the local user 100. The criteria may consist of identification of an event recording system 110, an at least one permissible range of values for an at least one attribute 208 of an at least one event record 206 of the event recording system 110, and a type of timestamp 210 of the at least one event record 206 of the event recording system 110. For example, the local user 100 may search for an at least one recording 302 of an at least one real-world event 202 identified by a prescription flow event recording system 204. The local user 100 may only be interested in the at least one recording 302 where a prescription with a certain identifier was filled. The search criteria may be an identification of the prescription flow event recording system 208, an Rx attribute 214 being the certain identifier, and an identification of the filled timestamp 218.

In operation 702, a client application search processor 104 may receive the search criteria from local user 100. In operation 704, the client application search processor 104 may search the event recording system 110 identified in the search criteria for an at least one event record 202 with all attributes 204 within the at least one permissible range of values in the search criteria. In operation 706, the client application search processor 104 may determine if any event records 202 were found in step 704. In operation 708, if no at least one event record 204 has been found, the client application search processor 104 may determine that no at least one event record 202 matches the search criteria of the local user 100. The client application search processor 104 may notify the local user 100 of that fact and the process 700 may terminate.

In operation 710, if an at least one event record 202 is found in step 704, client application search processor 104 may retrieve the timestamp 206 of the at least one event record 202 identified by the search criteria. In operation 712, the client application search processor 104 may search the DVR server 112 for an at least one video record 300 where a timing data 306 encompasses a timestamp 206 of the at least one event record 202 found in operation 704, the timestamp 206 being of the type of timestamp identified in the search criteria. That is, the client application search processor 104 may search the DVR server 112 for an at least one video record 300 where (1) a start time 308 is earlier than a timestamp 206 of the at least one event record 202 found in step 704 and (2) an end time 310 is later than the timestamp 206 of the same event record 202, the timestamp 206 being of the type of timestamp identified in the search criteria.

In operation 714, the client application search processor 104 may determine if an at least one video record 300 was found in operation 712. In operation 716, if no at least one video record 300 was found, client application search processor 104 may determine that there is no at least one video record 300 matching the search criteria of the local user 100. The client application search processor 104 may notify the local user 100 of that fact and the process 700 may terminate.

In operation 718, if an at least one video record 300 is found in step 712, the client application search processor 104 may make the at least one retrieved event record 204 and the at least one retrieved video record 300 available to the local user 100. Multiple video records 300 may encompass a timestamp 206 of a single event record 202 due to the possibility of multiple cameras 116.

In an exemplary embodiment of the present invention, the local user 100 may be presented with the at least one retrieved event record 202. For each event record 202, local user 100 may be presented with all retrieved video records 300 with a timing data 306 encompassing the search criteria-specified timestamp 206 of the event record 202. The local user 100 may be given the option of viewing the recording 302 of any of those video records 300.

In operation 720, when the local user 100 selects a recording 302 to view, client application search processor 104 may access the recording 302 on the DVR server 112 via the network 108. The client application search processor 104 may stream the recording 302 from the DVR server 112 to the remote user 122. The client application search processor 104 may cache the recording 302 in a client local storage 106 in case the local user 100 chooses to view the recording 302 again.

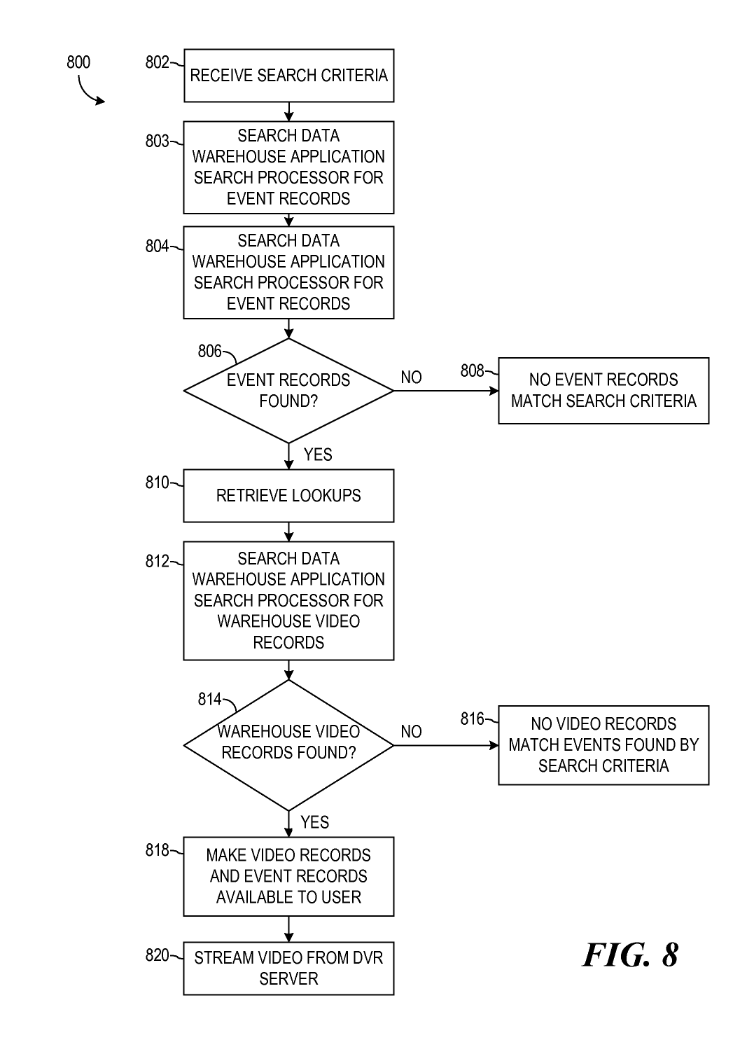

Referring now to FIG. 8, the process 800 describes a process for a remote user 122 retrieving video data using the present invention. The process 800 is similar to the process 700, but the remote user 122 may interface with an apparatus 102 through a data warehouse web page 120 via Internet 117. In the process 800, a data warehouse application search processor 118 acts as an intermediary for retrieval from an event recording system 201. As explained in the process 500, the data warehouse application search processor 118 may store event records 402 that are duplicate copies of event records 202 stored in an event recording systems 110. Thus, an event record 202 may be indirectly retrieved from an event recording system 201 by retrieving the duplicate copy stored in data warehouse application search processor 118. Further, since each event recording system 201 may correspond to a single warehouse event group 400, an identification of an event recording system 201 may simultaneously serve to identify the corresponding warehouse event group 400.

In process 800 the data warehouse application search processor 118 also acts as an intermediary for retrieval from a DVR server 112. As explained in the process 600, the data warehouse application search processor 118 may store a duplicate copy of the file name and timing data of each video record 300 as a warehouse video record 408. Thus, the warehouse video record 408 may be used to determine what video records 300 a given timestamp encompasses. The recordings 302 of all video records 300 with the same file names as the warehouse video records 408 may be retrieved.

The search criteria of the remote user 122 may consist of an identification of an event recording system 201, an at least one permissible range of values for an at least one attribute 208 of an at least one event record 206 of the event recording system 201, and a type of timestamp 210 of the at least one event record 206 of the event recording system 201. For example, the remote user 122 may search for an at least one recording 302 of an at least one real-world event 202 identified by a prescription flow event recording system 208. The remote user 122 may be only interested in recordings 302 where a prescription with a certain identifier was filled. The remote user 122's search criteria may be an identification of the prescription flow event recording system 208, an Rx attribute 214 being the certain identifier, and an identification of the filled timestamp 218.

In operation 802, a data warehouse web page 120 may receive the search criteria from the remote user 122 via the Internet 117. In operation 803, the data warehouse web page 120 may forward the search criteria to the data warehouse application search processor 118 for processing. Since each event recording system 201 may correspond to a warehouse event group 400, the identification of the event recording system 201 in the search criteria may also simultaneously identify the corresponding warehouse event group 400. In operation 804, the data warehouse application search processor 118 may search the warehouse event group 400 for an at least one event record with all attributes 404 within the at least one range of permissible values in the search criteria. In operation 806, the data warehouse application search processor 118 may determine if an at least one event record 402 was found in operation 804. In operation 808, if no at least one event record 404 was found, data warehouse application search processor 118 may determine that no at least one event record 402 matches the search criteria of the local user 100. The data warehouse application search processor 118 may notify the data warehouse web page 120 of that fact. The data warehouse web page 120 may notify the remote user 122 and the process 800 may terminate.

In operation 810, the data warehouse application search processor 118 may retrieve the timestamp 406 identified in the search criteria of the at least one event record 402 found in step 804. In operation step 812, the data warehouse application search processor 118 may search its warehouse video records 408 for all warehouse video records 408 where a timing data 412 encompasses a timestamp 406 of the at least one event record 402 found in step 804, the timestamp 406 being of the type of timestamp identified in the search criteria. That is, data warehouse application search processor 118 may search warehouse video records 408 for all warehouse video records 408 where (1) start time 414 is earlier than the timestamp 406 of an event record 402 found in step 804 and (2) end time 416 is later than the timestamp 406 of the same event record 802, the timestamp 406 being of the type of timestamp identified in the search criteria.

In operation 814 the data warehouse application search processor 118 may determine if an at least one warehouse video record 404 was found in operation 812. If no at least one warehouse video record 404 was found, the data warehouse application search processor 118 may determine in operation 816 that there is no at least one warehouse video record 404 matching the search criteria of the remote user 122. The data warehouse application search processor 118 may notify the data warehouse web page 120 of that fact. The data warehouse web page 120 may notify the remote user 122 and the process 800 may terminate.

If an at least one warehouse video record 408 is found in operation 812, in operation 818 the data warehouse application search processor 118 may forward the retrieved at least one event record 402 and the retrieved at least one warehouse video record 404 to the data warehouse web page 120. The data warehouse web page 120 may make the records available to the remote user 122. Multiple warehouse video records 404 may encompass a timestamp of a single event record 202 due to the possibility of multiple cameras 116.

In an exemplary embodiment of the present invention, remote user 122 may be presented with the retrieved at least one event record 402. For each retrieved event record 402, local user 100 may be presented with all retrieved warehouse video records 408 with timing data 412 encompassing the search criteria-specified timestamp 406 of the event record 402. The remote user 122 may be given the option of viewing the recording 302 of the corresponding video record 300 of any of those warehouse video records 408.

When the remote user 122 selects a recording 302 to view, the process 800 proceeds to step 820. The data warehouse web page 120 may access the recording 302 on the DVR server 112 via the Internet 117 and the network 108. The data warehouse web page 120 may stream the recording 302 from the DVR server 112 to the remote user 122.

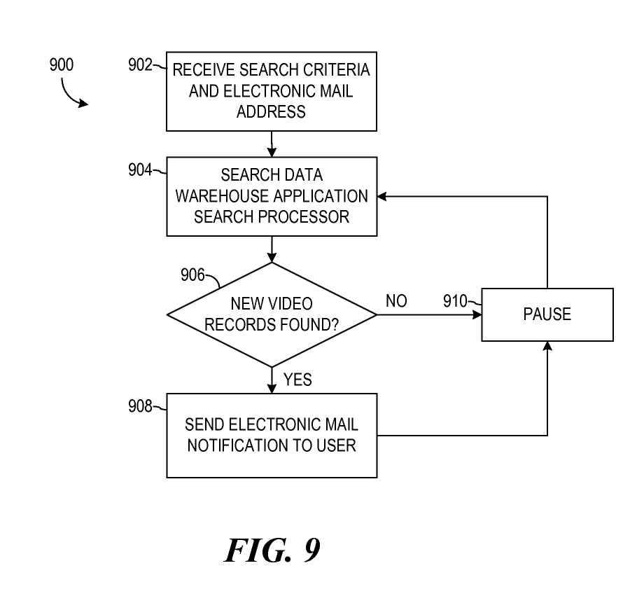

Referring to FIG. 9, the process 900 allows a remote user 122 to configure an apparatus 102 to automatically perform searches based on a given criteria. The process 900 may be used when, for instance, the remote user 122 would like to see a video recording 302 of every prescription the pharmacy fills in the future. In operation 902 the remote user 122 may submit the search criteria to a data warehouse web page 120, as well as an electronic mail address for the remote user 122 to be notified at. The data warehouse web page 120 may forward the request to a data warehouse application search processor 118.

In operation 904 a data warehouse application search processor 118 may perform a search using operations 803-814 of process 800 (FIG. 8). In operation 906 if an at least one warehouse video record 408 is found, the data warehouse application search processor 118 may determine if that at least one warehouse video record 408 is new. A new warehouse video record 408 may be a warehouse video record 408 that was added to the data warehouse application search processor 118 after the process 900 began and has not yet been the subject of an electronic mail notification to the remote user 122 in operation 908. If an at least one new warehouse video record 408 has been found, the process 900 performs operation 908. If no at least one warehouse video record 408 is found or no at least one warehouse video record 408 is new, the process 900 performs operation 910.

In operation 908 the data warehouse application search processor 118 may send an electronic mail notification to electronic mail address the remote user 122 submitted in operation 902. The electronic mail notification may contain a means for the remote user 122 to view the new warehouse video records 408 on the data warehouse web page 120, and a means for the remote user 122 to view the related recordings 302 of those warehouse video records 408. The process 900 then performs operation 910.

In operation 910 the process 900 may pause for an amount of time. This amount of time may depend on the particular embodiment of the apparatus 102. After the amount of time has passed, the process 900 returns to operation 904.

Although the invention has been described with reference to a specific embodiment, these descriptions are not meant to be construed in a limiting sense. Various modifications of the disclosed embodiments, as well as alternative embodiments of the invention will become apparent to persons skilled in the art upon reference to the description of the invention. It is therefore contemplated that the claims will cover any such modifications or embodiments that fall within the true scope and spirit of the invention.

We claim:

1. A method for video data retrieval comprising:
receiving a search criteria, the search criteria comprising:
an identification of an event recording system; and
an identification of a type of timestamp of an event record of the event recording system;
retrieving from the event recording system identified by the search criteria an at least one event record, each event record comprising a timestamp identified by the search criteria; and
retrieving from a digital video recorder server an at least one video record with a timing data encompassing the timestamp of the at least one event record, the timestamp of the type identified by the search criteria.

2. The method of claim 1, wherein the search criteria further comprises:
an identification of an at least one permissible range of values for an at least one attribute of the at least one event record of the event recording system identified by the search criteria; and
wherein the at least one event record retrieved from the event recording system further comprises the at least one attribute with values within the at least one permissible range of values specified by the search criteria for that attribute.

3. The method of claim 1, wherein the step of retrieving from an event recording system identified by the search criteria further comprises retrieving the at least one event record comprising the timestamp identified by the search criteria from a data warehouse application search processor, the data warehouse application search processor having received the at least one event record from the event recording system identified by the search criteria.

4. The method of claim 1, wherein the step of retrieving from a digital video recorder server identified by the search criteria further comprises:
retrieving an at least one warehouse video record with a timing data encompassing the timestamp of the at least one event record from a data warehouse application, the timestamp identified by the search criteria; and
retrieving from a digital video recorder server an at least one video record with a file name corresponding to the file name of the at least one warehouse video record.

5. The method of claim 1, wherein the retrieving from the event recording system is done across a computer network.

6. The method of claim 1, wherein the retrieving from the digital video recorder server is done across a computer network.

7. The method of claim 1, wherein the timestamp identified in the search criteria is a timestamp of one of a filling, verification, completion, or picking up of a prescription.

8. The method of claim 1, wherein the timestamp identified in the search criteria is a timestamp of one of a clocking into or out of a time clock.

9. The method of claim 1, wherein the at least one video record comprises a video recording created by a surveillance camera.

10. The method of claim 1, wherein an electronic mail notification of the retrieval of the at least one video record is sent to an electronic mail address.

11. A method for video data retrieval comprising:
sending a search criteria, the search criteria comprising:
an identification of an event recording system; and
an identification of a type of timestamp of an event record of the event recording system;
wherein the search criteria is sent to a search processor, the search processor configured for:
receiving the search criteria;
retrieving from the event recording system identified by the search criteria an at least one event record, each event record comprising a timestamp identified by the search criteria; and
retrieving from a digital video recorder server an at least one video record with a timing data encompassing the timestamp of the at least one event record, the timestamp of the type identified by the search criteria.

12. The method of claim 11, wherein the search criteria further comprises:
an identification of an at least one permissible range of values for an at least one attribute of the at least one event record of the event recording system identified by the search criteria; and
wherein the at least one event record retrieved from the event recording system further comprises the at least one attribute with values within the at least one permissible range of values specified by the search criteria for that attribute.

13. The method of claim 11, wherein the configuration of the search processor for retrieving from the event recording system comprises retrieving the at least one event record comprising the timestamp identified by the search criteria from a data warehouse application search processor, the data warehouse application search processor having received the at least one event record from the event recording system identified by the search criteria.

14. The method of claim 11, wherein the configuration of the search processor for retrieving from the digital video recorder comprises:
retrieving an at least one warehouse video record with a timing data encompassing the timestamp of the at least one event record from a data warehouse application, the timestamp identified by the search criteria; and
retrieving from a digital video recorder server an at least one video record with a file name corresponding to the file name of the at least one warehouse video record.

15. An apparatus for video data retrieval comprising:
a search processor;
an event recording system coupled to the search processor;
a digital video recorder server coupled to the search processor;
wherein the search processor is configured for:
receiving a search criteria, the search criteria comprising:
an identification of an event recording system; and
an identification of a type of timestamp of an event record of the event recording system;
retrieving from the event recording system identified by the search criteria an at least one event record, each event record comprising a timestamp identified by the search criteria; and
retrieving from a digital video recorder server an at least one video record with a timing data encompassing the timestamp of the at least one event record, the timestamp of the type identified by the search criteria.

16. The apparatus of claim 15, further comprising an at least one camera coupled to the digital video recorder server.
